(19) United States
(12) Patent Application Publication
(10) Pub. No.: US 2001/0036518 A1
(43) Pub. Date: Nov. 1, 2001

(54) Oven release food packaging

(76) Inventors: Robert V. Wright, Arden, NC (US); James F. Curtis, Clyde, NC (US); Kevin Cable, Waynesville, NC (US)

Correspondence Address: DORITY & MANNING, P.A., POST OFFICE BOX 1449, GREENVILLE, SC, 29602-1449, US

(21) Appl. No.: 09/858,162

(22) Filed: May 15, 2001

Related U.S. Application Data
(63) Continuation-in-part of application No. 09/169,550, filed on Oct. 9, 1998.

(30) Foreign Application Priority Data
Oct. 8, 1999 (US) PCT/US99/23427

(51) Int. Cl. B32B 1/02

(52) U.S. Cl. 428/34.2; 156/344

(57) ABSTRACT

The instant invention pertains to packaging which is suitable for protecting food during handling and storage and which also facilitates optimal heating and service of the food contained therein. In particular, a container having a recessed area surrounded by a sealing rim, and a multiplayer lid that comprises a base layer, an optional barrier layer, and an adhesive layer, are described. The lid is heat sealed to the top edge of the container which contains food to form a food package that may be frozen and that withstands shipping and distribution handling without the need for a protective outer folding carton. Such lids provide automatic venting when heated in a microwave or conventional oven and are easily separated from the container after heating. Unlike present lids which are difficult to remove and leave tears or unsightly exposed paper fibers which may absorb gravies and sauces, the instant lid is easily removed and results in a more convenient and esthetically pleasing package.

### RELATED APPLICATIONS

This application is a Continuation-in-Part of application Ser. No. 09/169,550 filed Oct. 9, 1998, and which is incorporated herein by reference.

### FIELD OF THE INVENTION

The instant disclosure relates to packaging which is suitable for protecting food products during handling, storage and shipment, and which also facilitates heating and service of the food contained therein. The instant disclosure relates to a package including a multilayer lid which may be heat sealed to the top edge of a container. Upon reheating the package, the lid is released from its sealed configuration which facilitates the removal of the lid by the consumer.

### BACKGROUND OF THE INVENTION

Commercially prepared food products are often placed in disposable packaging for distribution to consumers. Certain packaged food products, commonly referred to as frozen entrees, are typically stored at freezing or room temperatures and may be reconstituted by heating the package in a microwave or conventional radiant oven. The food product may be consumed directly from the disposable package, thus eliminating the need for serving dishes which require washing.

Various configurations exist for such packaging. For example, one type of packaging includes a container, such as a polyethylene terephthalate (‘PET’) coated ovenable paperboard tray, which is filled with a food product and covered with a film material, such as Mylar®, sealed to the top flange of the container. Unfortunately, the resulting package is not rugged enough to withstand conditions associated with shipping and handling and must be enclosed within an outer carton. This increases the amount of materials required as well as the total expense of the packaging. A number of such cartons are placed into a corrugated shipping container which is palletized for shipment to distribution centers.

Another packaging that is growing in popularity includes a paperboard lid which is heat sealed onto a container filled with a food product. These packages may be placed directly into corrugated shipping containers ready for distribution. Unfortunately, it is difficult to remove a paperboard lid that is attached securely enough to protect the package during distribution. The lid and the container may become torn, rendering the product unattractive to consumers. Lid removal is further complicated by the fact that the package and its contents are usually steaming hot, having been heated in an oven. These problems have been partially addressed by adding a half cut score around the lid that is being sealed for controlling the release of the lid. However, this results in an unsightly border of raw paper fibers around the top of the container flange which readily absorbs gravies and sauces from the entree during reconstitution and looks unattractive.

Although the above described packaging systems are adequate for storing and reheating food, a need continues to exist for an improved food packaging that uses less materials and adequately protects the product against damage caused by shock and vibration during shipping and distribution. A need also continues to exist for improved food packaging that is easily opened by consumers and presents an attractive appearance.

### BRIEF SUMMARY OF THE INVENTION

One embodiment of the instant disclosure pertains to a food package comprising a container having a recessed area for receipt of the food which is surrounded by a sealing rim, and a lid comprising a base layer and an adhesive layer, the adhesive layer being capable of heat sealing to the sealing rim of the container, maintaining a seal with the sealing rim of the container at temperatures below heating temperatures, and releasing the seal when subjected to heating temperatures.

Another embodiment of the instant disclosure pertains to a lid comprising a base layer and an adhesive layer, the adhesive layer being capable of heat sealing to the sealing rim of a container, maintaining a seal with the sealing rim of the container at temperatures below heating temperatures, and releasing the seal when subjected to heating temperatures. Alternative lid embodiments optionally include a third, intermediate barrier layer which may advantageously enhance the strength and rigidity of the food package.

It is yet another aspect of the present invention to provide an adhesive layer for a food package which exhibits superior “cold tack” properties while also offering a non-tearing self-release of the packaging lid when the package is exposed to conventional heating/cooking temperatures.

It is yet an additional aspect of the present invention to provide an adhesive for a paperboard lid which consists essentially of a blend of EMA with an acid-modified ethylene acrylate and more particularly where the adhesive layer consists essentially of about 80% EMA blended with about 20% acid-modified ethylene acrylate.

It is yet another aspect of the present invention to provide an adhesive layer suitable for use with a paperboard lid for a frozen entree in which the adhesive layer comprises between about 10% to 30% by weight of a stearic acid coated calcium carbonate. The presence of the calcium carbonate particles offers improvements in the extrusion of the adhesive layer by reducing the tendency of the adhesive layer to stick to the chill roller associated with the processing equipment.

The food package and lid systems of the instant disclosure advantageously exhibit sufficient strength and stability so as to obviate the need for surrounding packaging (beyond standard corrugated shipping containers) during shipping and distribution. The strength and stability afforded by the food package and lid systems of the instant disclosure thus contribute to the efficiency in the packaging process and reduce both cost and waste generally associated with food packaging systems.

These and other features, aspects, and advantages of the present invention will become better understood with reference to the following description and appended claims.

### BRIEF DESCRIPTION OF THE DRAWINGS

FIG. 1 depicts an embodiment of an oven release food packaging according to the instant disclosure; and

FIG. 2 depicts an embodiment of a lid, which includes a base layer, a barrier layer, and an adhesive layer, according to the instant disclosure.

FIG. 3 depicts an alternative embodiment of the lid which includes a base layer, a barrier layer, and an adhesive layer along with an optional skin-coat layer.

### DETAILED DESCRIPTION OF THE PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions

In describing the various figures herein, the same reference numbers are used throughout to describe the same material, apparatus or process pathway. To avoid redundancy, detailed descriptions of much of the apparatus once described in relation to a figure is not repeated in the descriptions of subsequent figures, although such apparatus or process is labeled with the same reference numbers.

The instant oven release packaging generally includes a container and a multilayer lid heat sealed thereto. The food contents of the packaging may be frozen to achieve the desired level of food preservation. Once frozen, the packaging of the instant disclosure exhibits sufficient strength and integrity to withstand shipping, distribution and handling without the need for a protective outer carton. The oven release packaging also provides for automatic venting of the packaging when heated in a microwave or conventional oven and allows for easy removal of the lid from the container after heating. Tearing of the package during lid removal is eliminated, thereby resulting in a more esthetically pleasing serving container. The instant oven release packaging is also easier to manufacture than present packaging systems, uses less materials and energy, and is therefore less costly to produce.

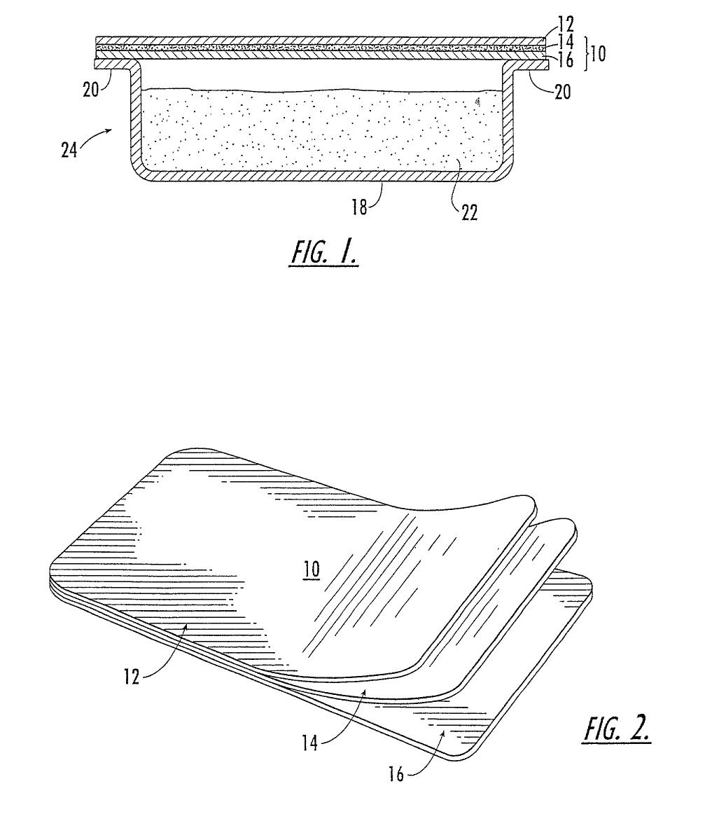

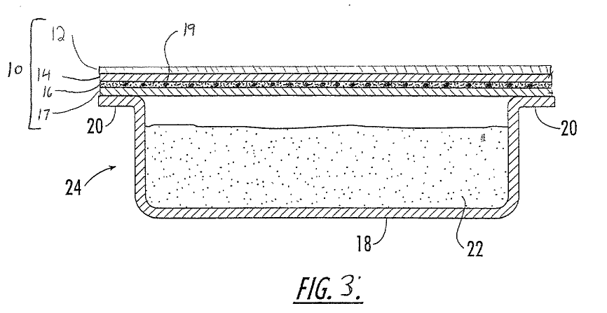

As shown in FIG. 1, a food package 24 according to the present disclosure includes a lid 10 and a food container 18. As shown in FIG. 1 and more specifically in FIG. 2, the lid 10 includes a base layer 12, an optional barrier layer 14, and an adhesive layer 16. The base layer 12 may be selected from suitable materials known in the food packaging industry, such as paper, paperboard, resinous materials (e.g., plastics), metal, or any combination of these materials. In a preferred embodiment of the instant disclosure, the base layer 12 is comprised of 0.019 inch caliper milk carton base stock available from Blue Ridge Paper Products, Inc. (Waynesville, N.C.). Clay coated SBS (“solid bleached sulfate”) board, such as 18 point SBS clay coated board available from Georgia Pacific Corporation, is a preferred lid material when high quality graphics are required and a clay print surface is needed.

The optional barrier layer 14 may be extruded onto the base layer 12 and, when present, typically provides a grease and moisture barrier. The barrier layer 14 may also provide strength and rigidity to the container package during shipping and help to prevent damage or tearing which may occur when the lid is removed. The barrier layer 14 may be metal foil, filled or unfilled polyethylene terephthalate (PET), polybutylene terephthalate (PBT), ethylene vinyl alcohol (EVOH), polyethylene, polypropylene, nylon, metal foils, acrylonitrile-butadiene-styrene (ABS), polycarbonate, acrylonitrile copolymers, polystyrenes, and polyvinyl chloride. In a preferred embodiment, the barrier layer 14 is comprised of PET, such as 7807 PET available from M & G Polymers USA, LLC.

The barrier layer 14 may be extruded onto the base layer 12 using conventional extrusion technology and is typically added at a level to provide the desired functional properties, e.g., suitable grease and/or moisture resistance. In a preferred embodiment, the barrier layer 14 is PET extruded onto the base layer 12 in an amount of about 20 pounds per 3000 square feet.

In general, the adhesive layer 16 is extruded onto the barrier layer 14 (when present) or the base layer 12, and is capable of being heat sealed to the sealing rim 20 of a food container 18 to create a food package 24. The adhesive layer 16 maintains the bond between the sealing rim 20 of the food container 18 and the barrier layer 14 at temperatures below heating temperatures. By “heating temperature” is meant the usual oven (whether conventional or microwave) temperature(s) customarily utilized to heat frozen food, e.g., a TV dinner, to a serving temperature. The term “heating temperature” is also meant to describe the serving temperature of a microwave food item present within a food package 25. It is well understood and appreciated that a microwave oven relies upon the heating of food products directly in that the ambient air temperature surrounding the package is typically much cooler.

In particular, the adhesive layer 16 will typically maintain a bond between the sealing rim 20 of the food container 18 and the barrier layer 14 (when present) or base layer 12 in a temperature range of between about 40° F. to about +150° F. When the food package 24 is heated in a microwave or conventional oven to a heating temperature, the adhesive layer 16 softens, allowing the food package 24 to self-vent, e.g., automatically release steam from within the package 24. In addition, once the package 24 reaches a heating temperature, the lid 10 may be easily and effectively removed from the food container 18 by the user, i.e., with ease and without tearing the lid 10.

The adhesive layer 16 is selected from a material that will bond and release in the temperature ranges described hereinabove. Preferred materials for use in adhesive layer 16 includes acrylate polymers, copolymers and mixtures thereof, and particularly ethyl methyl acrylate (“EMA”), a blend of EMA with maleic anhydride, acid modified EMA, EMA blended with acid modified ethylene acrylate, ethylene-butyl-acrylate copolymer, or modified polyethylenes. In a preferred embodiment of the present disclosure, the adhesive layer 16 is EMA blended with acid-modified ethylene acrylate, and particularly a blend of 80% Eastman EMAC SP2261 available from Eastman Chemical Company (Longview, Tex.) and 20% of DuPont 2014 acid-modified ethylene acrylate available from DuPont (Wilmington, DE), or a blend of 80% Eastman EMAC SP 2207, and 20% of DuPont Bynel 2014 acid-modified ethylene acrylate. Additionally preferred adhesive materials are prepared by blending EMA (e.g., Eastman EMAC SP 2207) with acid-modified ethylene acrylate (e.g., Bynel 2014) at varying weight ratios, depending on the precise adhesive properties desired. The preferred materials described herein have exhibited superior “cold tack” properties as compared to an adhesive layer of EMA alone. The term “cold tack” refers to the adhesive performance of materials at temperatures below room temperature, in particular, temperatures below freezing. For example, such temperatures include those temperatures at which frozen foods are customarily stored.

The adhesive layer 16 may be extruded onto the barrier layer 14 (when present) or the base layer 12 utilizing conventional extrusion equipment in an amount to achieve the desired adhesion to the food container 18. In a preferred embodiment of the present disclosure, the adhesive layer 16 is extruded onto the barrier layer 14 in an amount of 8 pounds per 3000 square feet.

The lid material may be produced in rolls, commonly referred to as “roll stock,” which may then be cut to specific dimensions to fit a particular tray. FIG. 2 depicts one embodiment of a lid which has been cut from roll stock. Paperboard serves as the base layer 12. Extruded onto the base layer 12 is a barrier layer 14 of 20 pounds per 3000 square feet of polyethylene terephthalate (PET), which provides, inter alia., protection from grease and moisture. Extruded onto the barrier layer 14 is an adhesive layer 16 of 8 pounds per 3000 square feet of methyl ethyl acrylate (MEA). Adhesive layer 16 adheres lid 10 to container 18 during storage, shipping and handling, and automatically separates the lid 10 from the container 18 at heating temperatures.

As shown in FIG. 1, the lid of the instant disclosure may be used to seal a container 18 having a recessed area 22 surrounded by a sealing rim 20. In a preferred embodiment, the container 18 is fabricated from conventional materials used in the food industry which provide appropriate dimensional stability, e.g., when subjected to heat, and are inert with respect to the food to be packaged therein. For example, container 18 may be fabricated from materials such as paperboard, metal, plastics, and various laminates.

In addition to the above described base, barrier, and adhesive layers, the instant lid may also comprise further layers to provide additional properties to the lid, e.g., extra strength if desired for a particular application. The method of application of the above coatings to the base layer may be by extrusion coating or coextrusion coating (where more than one different coating is applied through one extrusion die), or by lamination of the coatings using an extrusion lamination adhesive or tie coat.

One such additional layer is seen in FIG. 3 as skin layer 17 which may comprise a thin skin-coat applied at an amount of about 2 pounds per 3000 square feet. The skin-coat is a thin coating of polyethylene, EVOH, nylon, or combinations of the above which is applied as an outermost layer over the adhesive layer 16. The skin-coat offers protection against the EMA from sticking to the chill roll on the extruder during the extrusion coating operation. Generally, as the amount of EMA present in an extrusion blend increases, the greater tendency there is for the EMA to stick to the chill roll. The thin layer of the skin-coat, such as polyethylene, is present in a sufficiently small amount so as not to interfere with the EMA/PET seal in that the thin skin-coat layer is “melted through” and allows the formation of a secure bond between the adhesive and the PET of the coated tray.

As further seen in reference to FIG. 3, an additional modification believed useful to the adhesive layer includes the incorporation of a fine powder 19 of calcium carbonate at an approximately 10% to 30% loading by weight. The particle size of the calcium carbonate may include that as commonly used as filler material in the paper-making industry. As typically used, the calcium carbonate is coated with stearic acid. It is believed that the inclusion of the calcium carbonate into the adhesive layer may also help avoid the adhesive layer from sticking to the chill roller during extrusion.

In use, a food product is typically deposited into the recessed area 22 of the food container 18 and a lid 10 is then sealed to the sealing rim 20 by the simultaneous application of heat and pressure in the area of the seal. The resulting food package 24 is functional during storage and distribution of the food product contained in the package over a temperature range of −40° F. to +150° F. In particular, the food package 24 advantageously exhibits sufficient strength and stability to obviate the need for a further carton or protective package. Notwithstanding the strength and stability exhibited by food package 24, when placed in a microwave or conventional oven, such as for the reconstitution or warming of frozen foods to a serving temperature, the lid's extruded adhesive coating automatically releases the lid 10 from the container 18. This automatic release permits venting of vapors generated within the package during heating and facilitates lid removal for consumption of the food contents.

In addition, it has been found that adding the PET layer to the paperboard followed by the application of an EMA adhesive improves the tear properties of the resulting board. In the examples which follow where only EMA was applied to a carton board stock material, resulting lids would occasionally tear from the container if the lid was removed too rapidly or if the packaging contents had partially cooled. The addition of PET to the board layer has surprisingly been found to improve the strength and integrity of the lid so that tearing of the lid from the reheated container is avoided.

Thus, the lid of the present disclosure exhibits numerous advantages over conventional flexible lid materials which are often difficult to remove from containers after reconstitution of entrees during preparation for serving. In addition, flexible lid materials contribute little structural rigidity to the food package, particularly when contrasted with the lid of the present disclosure, and such flexible lids generally require an outer carton to protect the integrity of the food package during subsequent handling. Because the instant lid eliminates the need for a protective outer carton, less materials are required.

### EXAMPLES

The examples set forth below were conducted using the materials as indicated. To the extent some of the materials listed in the examples are no longer available from the indicated companies, the detailed description set forth above provides additional supplier information on where similar materials may be obtained.

### Example 1

10 pounds per 3000 square feet of Chevron 2207 EMA is extrusion coated onto 0.017-inch caliper milk carton stock. The EMA coated board is cut into lids and heat sealed to ovenboard trays using a Sentinel heat sealer at 400° F. with a dwell time of 1.5 seconds. A small flap is cut into the tray lid, 60 ml of water is added, and the flap closed. Trays are placed in a microwave oven for 4 minutes at a 10 setting, and the lid is easily removed from the package thereafter. The lids are also easily removed from comparable trays heated in a conventional radiant oven at 375° F. for 30 minutes. Similar results are obtained from tests using lids made of 0.017-inch caliper milk carton stock extrusion coated with 15 pounds per 3000 square feet of Chevron 2207 EMA.

### Example 2

Chevron 2268 EMA is extrusion coated onto the non-clay side of 18 point SBS clay-coated board available from Georgia Pacific at about 8 pounds per 3000 square feet. The EMA-coated board is cut into lids which are heat sealed to PET-coated trays using a Sentinel heat sealer at 500° F., with a dwell time of 2 seconds and air pressure gauge setting of 60 psi. A slit is cut in the lid to allow the tray to be half filled with water. The contents of the trays are then frozen. The frozen trays containing ice are dropped from waist height onto the floor. No damage results when the tray is dropped to land on its base. The lids are easily removed, generally without fiber tear, when trays are heated in a microwave until the water boils.

### Example 3

10 pounds per 3000 square feet of DuPont 8111 PET and 5 pounds per 3000 square feet of Chevron 2207 EMA are coextruded onto 0.019 inch caliber Champion milk carton base stock. A layer of PET is coated onto the paperboard and a layer of EMA coated onto the PET layer. Lids cut to fit ovenboard trays are heat sealed to trays using a Sentinel heat sealer at 400° F. with a dwell time of 1.5 seconds. A small flap is cut into the tray lid, 60 ml of water is added, and the flap closed. Trays are placed in a microwave oven for 4 minutes at a 10 setting. The lids are easily removed. Comparable trays are also placed in a conventional radiant oven at 375° F. for 30 minutes and lids are easily removed.

### Example 4

Traytuf 7087 PET produced by Shell Chemical Company and Chevron 2268 EMA are coextruded onto the non-clay side of 18 point Georgia Pacific SBS paperboard. The PET is extruded next to the board with the EMA on the outside surface to provide a heat seal to PET-coated ovenboard trays. Lids formed from the PET/EMA coextruded board show excellent performance with respect to microwave oven release from trays containing frozen lasagna. Release in a conventional radiant oven is also excellent. Besides preventing the intrusion of grease through the paperboard, the PET layer reinforces the lid structure and prevents tearing of the paperboard during removal of the lid from the tray after reconstitution.

### Example 5

The following release coatings are co-extruded onto 0.0135-inch paperboard:

1) Shell Chemical Company Traytuf 7087 PET, 20 pounds per 3000 square feet is co-extruded with 8 pounds per 3000 square feet of Chevron 2261 EMA on the outside.

2) Shell Chemical Company Traytuf 7087 PET, 20 pounds per 3000 square feet is co-extruded with 8 pounds per 3000 square feet of Chevron 2207 EMA on the outside.

3) Shell Chemical Company Traytuf 7087 PET, 20 pounds per 3000 square feet is co-extruded with 8 pounds per 3000 square feet of a blend of 80% Chevron 2261 EMA and 20% of DuPont 2014 acid-modified ethylene acrylate.

4) Shell Chemical Company Traytuf 7087 PET, 20 pounds per 3000 square feet is co-extruded with 8 pounds per 3000 square feet of a blend of 80% Chevron 2207 EMA, and 20% of DuPont 2014 acid-modified ethylene acrylate.

Evaluations are conducted on the cold tack of the PET coextrusions with the Chevron EMA 2261 and EMA 2207 blends with DuPont 2014 acid-modified ethylene acrylate. Comparison are made to the PET coextrusion with Chevron EMA 2261, 2260, 2268 and 2207 without the DuPont 2014 added. Lids are sealed onto trays and a closeable flap cut in the lid. Water is added to the tray which is placed in a freeze overnight. The trays are removed and dropped on their long edge from waist height. Seals remained intact on lids using the EMA 2261 and 2207 blends with DuPont 2014, indicating superior cold tack for these adhesives. The lid seals without the DuPont 2014 failed under the same conditions.

As noted above, additional skin-coat layers may be useful in establishing commercial production runs of the above adhesive blends. Additionally, the incorporation of a stearic coated calcium carbonate powder into the adhesive layer may also bring about beneficial improvements in the workability of the EMA adhesive coating layer.

These and other modifications and variations to the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention.

What is claimed is:

1. A method of releasing an intact paperboard lid from a food package, the method comprising the steps of:
providing a food containing package comprising a container having an upper margin defining a rim; and,
a paperboard lid, having an upper surface and a lower surface, an adhesive layer positioned along said lower surface of said paperboard lid, said adhesive layer comprising an EMA blended with an effective amount of an acid-modified ethylene acrylate, said adhesive layer forming a heat seal between said upper rim and said lower lid surface;
raising the temperature of said food within said package to a reheating temperature, said temperature above about 180° F.;
releasing in response to said temperature raising step, the heat seal between said container margin and said adhesive layer; and, removing said paperboard lid from said container, said paperboard lid being removed intact without tearing of the paperboard.

2. The method according to claim 1 wherein said adhesive layer exhibits improved “cold tack” properties when compared to an adhesive layer without an effective amount of acid modified ethylene acrylate.

3. The method according to claim 1 wherein said lid further comprises a layer of PET positioned between said paperboard lid and said adhesive layer.

4. The method according to claim 1 wherein said adhesive layer further comprises from about 10% to about 30% by weight of a calcium carbonate powder.

5. The method according to claim 1 wherein said paperboard lid further comprises an exterior skin-coat layer of polyethylene adjacent said adhesive layer.

6. The method according to claim 4 wherein said paperboard lid further comprises an exterior skin-coat layer of polyethylene adjacent the adhesive layer.

7. The method according to claim 1 wherein said adhesive further comprises a blend of 80% by weight of EMA with 20% by weight of acid-modified ethylene acrylate.

8. The method according to claim 1 wherein said adhesive layer consists essentially of a blend of EMA and acid-modified ethylene acrylate.

9. The method according to claim 1 wherein said adhesive layer consists essentially of a blend of about 80% by weight of EMA and 20% by weight acid-modified ethylene acrylate.

10. A food package comprising:
a container having a receptacle adapted for receiving food, said container further defining an upper margin defining a rim;
a paperboard lid having an upper surface and a lower surface, the lid having an adhesive layer positioned along said lower lid surface, the adhesive layer comprising a blend of EMA with an effective amount of an acid-modified ethylene acrylate, said adhesive layer forming a heat seal between said upper rim and said lower lid surface;
wherein said adhesive layer maintains a heat seal at a temperature range from at least about −40° F. to +150° F., said adhesive layer detaching itself from the rim of said container where food placed within said sealed container is heated to a serving temperature.

11. The food package according to claim 10 wherein said lid further comprises a layer of PET positioned between said paperboard lid and said adhesive layer.

12. The food package according to claim 10 wherein said adhesive layer further comprises from about 10% to about 30% by weight of a calcium carbonate powder.

13. The food package according to claim 10 wherein said paperboard lid further comprises an exterior skin-coat layer of polyethylene adjacent said adhesive layer.

14. The food package according to claim 12 wherein said paperboard lid further comprises an exterior skin-coat layer of polyethylene adjacent the adhesive layer.

15. The food package according to claim 10 wherein said adhesive layer further comprises a blend of about 80% by weight of EMA and about 20% by weight of acid-modified ethylene acrylate.

16. The food package according to claim 1 wherein said adhesive layer consists essentially of a blend of EMA and acid-modified ethylene acrylate.

17. The food package according to claim 10 wherein said adhesive layer consists essentially of a blend of about 80% by weight of EMA and about 20% by weight of an acid-modified ethylene acrylate.
